(19) United States
(12) Patent Application Publication
(10) Pub. No.: US 2022/0280854 A1
(43) Pub. Date: Sep. 8, 2022

(54) GOLFER-ORIENTED INFORMATION PROVIDING METHOD AND INFORMATION PROVIDING SYSTEM

(71) Applicant: Sumitomo Rubber Industries, Ltd., Kobe-shi (JP)

(72) Inventors: Kazuya KAMINO, Kobe-shi (JP); Atsushi HIRANO, Kobe-shi (JP); Ken YAMAMOTO, Kobe-shi (JP); Takuya SEKINE, Kobe-shi (JP)

(73) Assignee: Sumitomo Rubber Industries, Ltd., Kobe-shi (JP)

(21) Appl. No.: 17/681,849

(22) Filed: Feb. 28, 2022

(30) Foreign Application Priority Data
Mar. 3, 2021 (JP) 2021-033225

(51) Int. Cl. A63B 69/36; A63B 71/06; G10L 15/22; G10L 15/26; G10L 15/08

(52) U.S. Cl. CPC A63B 69/36; A63B 71/0622; G10L 15/22; G10L 15/26; G10L 15/08; A63B 2071/063; A63B 2220/808; G10L 2015/225; G10L 2015/088

(57) ABSTRACT

A method for providing information to a golfer includes a voice information acquiring step of acquiring, by a portable terminal, voice information emanated by the golfer, an information identifying step of analyzing the voice information by the portable terminal or a computer with the voice information received from the portable terminal to identify a piece of advice information suitable for the golfer from an advice information table including a plurality of pieces of the advice information recorded in advance in the portable terminal or the computer, and an information output step of outputting the piece of the advice information identified in the information identifying step from the portable terminal in a manner perceptible to the golfer.

### CROSS-REFERENCE TO RELATED APPLICATION

This application claims priority to Japanese Application No. 2021-033225, filed Mar. 3, 2021, the entire contents of which is incorporated herein by reference.

### FIELD

The present disclosure relates to information providing methods and information providing systems for providing useful information to golfers.

### BACKGROUND

A golf play support system for providing individual advice for golfers during their play has been proposed in Japanese Unexamined Patent Publication No. 2005-253858, for example.

Further, a system and a method for supporting swing improvement for golfers have been proposed in Japanese Unexamined Patent Publication No. 2019-166311.

### SUMMARY

According to an aspect, a golfer-oriented information providing system for providing information to a golfer, can comprise: a portable terminal for acquiring voice information emanated by the golfer; and a computer for receiving the voice information from the portable terminal, wherein the computer executes the steps comprising: a step of analyzing the voice information; a step of identifying a piece of advice information suitable for the golfer from an advice information table including a plurality of pieces of the advice information recorded in advance; and a step of outputting the identified piece of the advice information to the portable terminal in a manner perceptible to the golfer.

According to an aspect, a golfer-oriented information providing method can comprise a voice information acquiring step of acquiring, by a portable terminal, voice information emanated by the golfer, an information identifying step of analyzing the voice information by the portable terminal or a computer with the voice information received from the portable terminal to identify a piece of advice information suitable for the golfer from an advice information table including a plurality of pieces of the advice information recorded in advance in the portable terminal or the computer, and an information output step of outputting the piece of the advice information identified in the information identifying step from the portable terminal in a manner perceptible to the golfer.

By adopting the above configuration in the golfer-oriented information providing method and the information providing system of the present disclosure, golfers can more easily receive advice information.

### BRIEF DESCRIPTION OF THE DRAWINGS

FIG. 1 is a configuration diagram showing an embodiment of a golfer-oriented information providing system.

FIG. 2 is a block diagram showing a portable terminal of the present embodiment.

FIG. 3 is a block diagram showing a computer of the present embodiment.

FIG. 4 is a diagram showing the structure of a unique information table of the present embodiment.

FIG. 5 is a diagram showing the structure of an advice information table of the present embodiment.

FIG. 6 is a diagram showing the structure of an evaluation table of the present embodiment.

FIG. 7 is a flowchart showing a processing procedure of a golfer-oriented information providing method of the present embodiment.

FIG. 8 is a diagram showing a unique information input screen of the present embodiment.

FIG. 9A is a diagram showing a state in which a golfer emanates voice information.

FIG. 9B is a diagram illustrating a state in which advice information is output from the portable terminal.

FIG. 10 is a flowchart showing a processing procedure of an information identifying step of the present embodiment.

FIG. 11 is a diagram illustrating an example of text information (voice information) and keywords.

FIG. 12 is a diagram showing an example of a learning model.

FIG. 13 is a diagram showing an evaluation input screen of the present embodiment.

FIG. 14 is a diagram showing the structure of an advice information table of another embodiment of the present disclosure.

FIG. 15 is a diagram showing the structure of the advice information table of still another embodiment of the present disclosure.

### DETAILED DESCRIPTION

In the following, embodiments of the present disclosure will now be described in detail in conjunction with accompanying drawings. It must be understood that the drawings may contain exaggerations and representations that differ from the actual dimensional ratios of the structure in order to aid in understanding the content of the disclosure. Further, throughout the embodiments, the same reference sign is assigned to the same or common elements and redundant description is omitted. Furthermore, the embodiments and the specific configurations represented in the drawings are for the purpose of understanding the subject matters of the present disclosure, and the present disclosure is not limited to the specific configurations depicted in the drawings.

A golfer-oriented information providing method (hereinafter may be simply referred to as “information providing method”) of the present embodiment can be to provide information to golfers. In the present embodiment, the information to be provided to the golfer may be exemplified as advice information suitable for that golfer. It should be noted that other information may be provided along with the advice information. Further, in the information providing method of the present embodiment, while information can be provided to a golfer during play on a golf course, the information may be provided before or after the play.

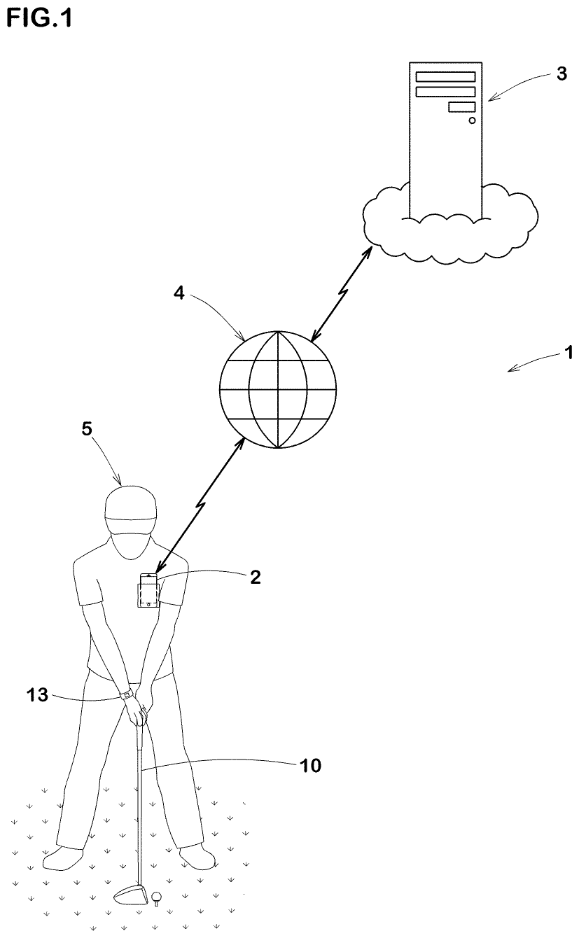

In the information providing method of the present embodiment, a golfer-oriented information providing system (which may be hereinafter simply referred to as “information providing system”) can be used. FIG. 1 is a structural diagram showing a golfer-oriented information providing system 1 of the present embodiment.

### Information Providing System (First Embodiment)

The information providing system 1 of the present embodiment can include a portable terminal 2 and a computer 3. The portable terminal 2 and the computer 3 can be connected to each other via a communication network 4 such as WAN (Wide Area Network) or LAN (Local Area Network), for example. As the communication network 4 of the present embodiment, WAN (Internet) can be adopted. The information providing system 1 may include a plurality of portable terminals.

### [Portable Terminal]

The portable terminal 2 of the present embodiment can be an electronic device portable by a golfer 5 (for example, a smartphone, tablet-type computer, or the like). As the portable terminal 2 of the present embodiment, a smartphone can be adopted. However, this is not particularly limited, and any device connectable to the computer 3 via the communication network 4 can be used.

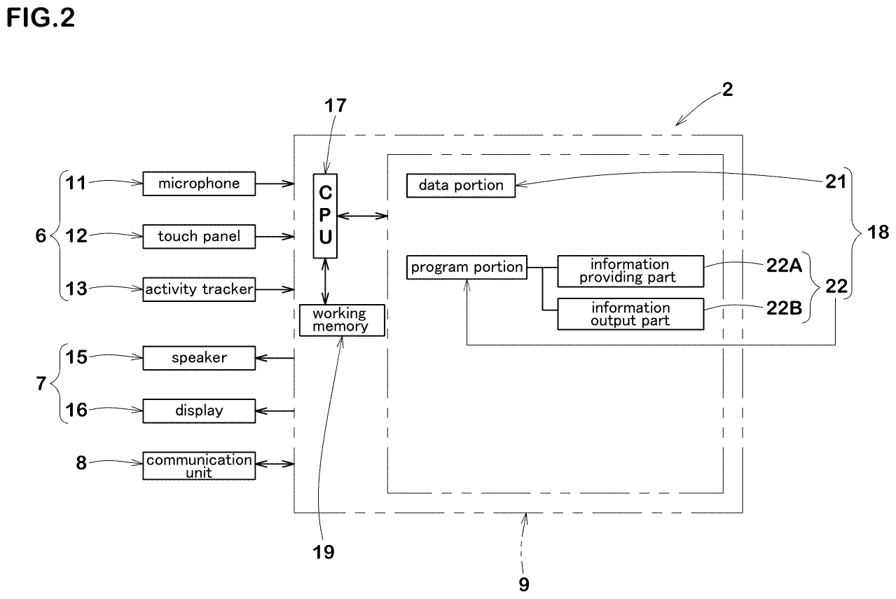

FIG. 2 is a block diagram showing the portable terminal 2 of the present embodiment. The portable terminal 2 of the present embodiment can include an input unit 6, an output unit 7, a communication unit 8, and an arithmetic processing device 9.

The input unit 6 of the present embodiment can be to input information emanating from the golfer 5 (shown in FIG. 1) to the portable terminal 2. The input unit 6 of the present embodiment can include a microphone 11 for inputting voice information and a touch panel 12 for inputting text information and the like. It should be noted that a keyboard may be used in place of the touch panel 12. Furthermore, the input unit 6 of the present embodiment may include an activity tracker 13 to measure activity information of the golfer 5 (for example, heart rate, blood pressure, number of steps, and so forth). The activity tracker 13 can be, for example, attached onto the body of the golfer 5. Further, the input unit 6 may include a camera and the like to input image information.

The output unit 7 of the present embodiment can be to output information perceivable by the golfer 5 (shown in FIG. 1) from the portable terminal 2. The perceivable information can include, for example, voice information, visual information, and so forth.

The output unit 7 of the present embodiment can include a speaker 15 to output voice information and a display 16 to output visual information (for example, text information and image information). As the display 16 of the present embodiment, a touch panel display integrally configured with the touch panel 12 of the input unit 6 can be used, however, it is not particularly limited to this.

The communication unit 8 of the present embodiment can be to transmit information to the computer 3 and receive information from the computer 3. The communication unit 8 can be connected to the communication network 4 (shown in FIG. 1). As the communication unit 8 of the present embodiment, one compliant with a mobile communication system (for example, a fourth-generation or fifth-generation mobile communication system or the like) can be adopted, for example, but it is not limited to this.

The arithmetic processing device 9 of the present embodiment can include an arithmetic unit (CPU) 17 performing various arithmetic operations, a storage unit 18 storing data, programs, and so forth, and a working memory 19.

The storage unit 18 of the present embodiment can be, for example, a non-volatile information storage device consisting of a flash memory or the like. The storage unit 18 can include a data portion 21 and a program portion 22.

The data portion 21 can store information required for execution of the information providing method and information acquired by execution of the information providing method.

The program portion 22 can be a program (application) to execute the information providing method. The program portion 22 can be executed by the arithmetic unit 17. The program portion 22 of the present embodiment can be installed on the portable terminal 2 prior to the execution of the information providing method. The program portion 22 of the present embodiment can include, for example, an information providing part 22A and an information output part 22B.

The information providing part 22A of the present embodiment can acquire information emanating from the golfer 5 (voice information, text information, activity information, and so forth) from the input unit 6 (the microphone 11, the touch panel 12, the activity tracker 13, and so forth). Further, the information providing part 22A can have a function of providing (transmitting) the acquired information to the computer 3 via the communication unit 8. Therefore, the portable terminal 2 can be enabled to acquire voice information uttered by the golfer 5 and provide that voice information to the computer 3.

The information output part 22B of the present disclosure has a function of acquiring information outputted from the computer 3 (in the present example, the advice information and the like, which will be described later) via the communication unit 8. Further, the information output part 22B has a function of outputting the acquired information from the output unit 7 (for example, the speaker 15, the display 16, and so forth).

### [Computer]

As shown in FIG. 1, the computer 3 of the present embodiment can be a server (cloud server), for example.

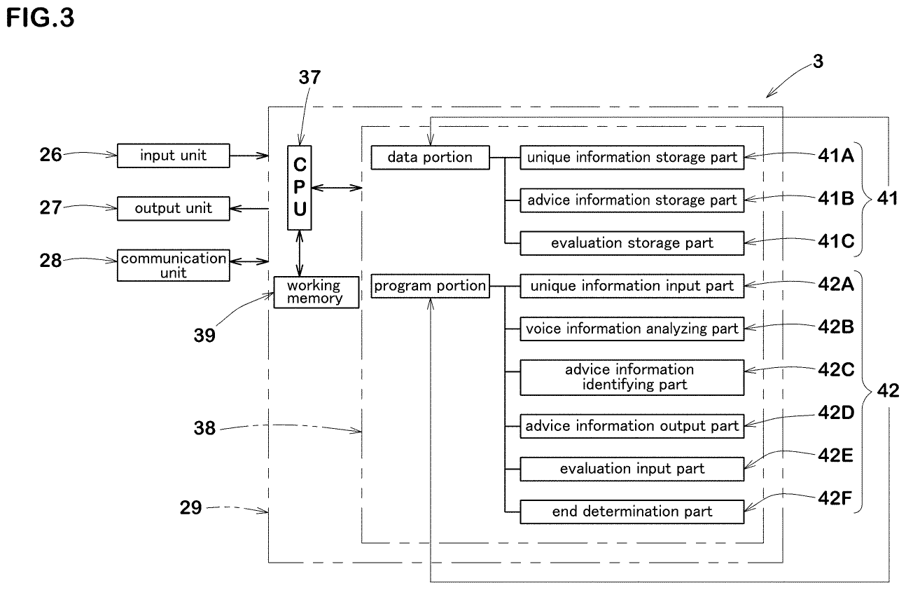

FIG. 3 is a block diagram showing the computer 3 of the present embodiment. The computer 3 of the present embodiment can include an input unit 26, an output unit 27, a communication unit 28, and an arithmetic processing device 29.

### [Input Unit and Output Unit]

As the input unit 26, a keyboard, a mouse, or the like can be used, for example. As the output unit 27, a display, a printer, or the like can be used, for example.

### [Communication Unit]

The communication unit 28 of the present embodiment can receive information from the portable terminal 2 (shown in FIG. 1) and transmit information to the portable terminal 2. The communication unit 28 can be connected to the communication network 4 (shown in FIG. 1). The communication unit 28 of the present embodiment can be a network adaptor compliant with the Ethernet standards, for example, but it is not particularly limited to this.

### [Arithmetic Processing Device]

The arithmetic processing device 29 of the present embodiment can include an arithmetic unit (CPU) 37 performing various arithmetic operations, a storage unit 38 storing data, programs, and so forth, and a working memory 39.

### [Storage Unit]

The storage unit 38 can be a non-volatile information storage device consisting of a magnetic disc, optical disc, SSD, or the like, for example. The storage unit 38 can be provided with a data portion 41 and a program portion 42.

### [Data Portion]

The data portion 41 can be for storing information required for execution of the information providing method, calculation results acquired by execution of the information providing method, and so forth. The data portion 41 of the present embodiment can have a unique information storage part 41A and an advice information storage part 41B. Further, the data portion 41 of the present embodiment can have an evaluation storage part 41C.

### [Unique Information Storage Part]

The unique information storage part 41A can be to store unique information of the golfer 5 (shown in FIG. 1). The unique information storage part 41A of the present embodiment can store a unique information table including unique information of a plurality of golfers 5.

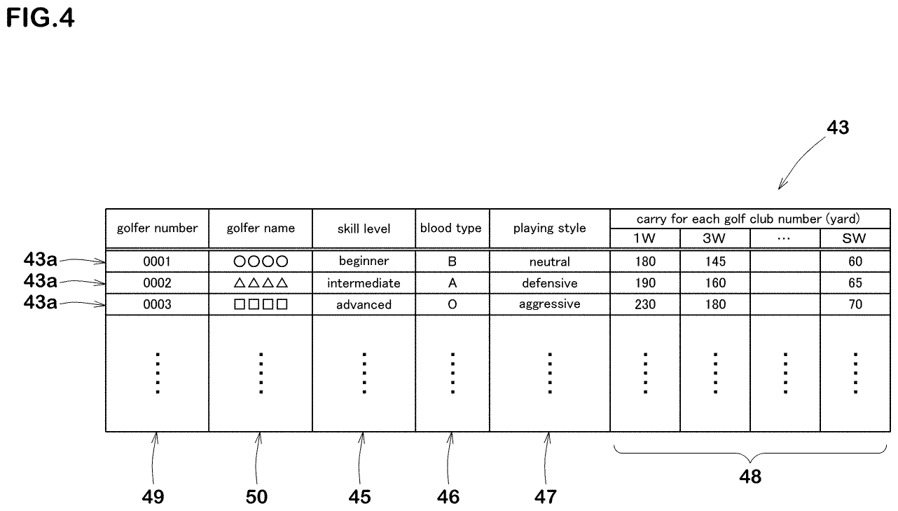

FIG. 4 is a diagram showing the structure of the unique information table 43 of the present embodiment. In the present embodiment, each record (43a) of the unique information table 43 can contain unique information of one golfer 5 inputted therein on a one-to-one basis. In the present embodiment, the unique information can be information regarding unique predisposition or characteristics each individual golfer 5 has. The unique information of the present embodiment can include at least one or a plurality of a skill level 45, a blood type 46, and a playing style 47 of the golfer 5, and a carry 48 for each golf club number.

In the present embodiment, all of the above-described pieces of unique information may be included. However, it is not limited to this. For example, depending on information to be provided to the golfer 5 (shown in FIG. 1), only part of these pieces of unique information may be included, or unique information other than the above may be included. The unique information of the present embodiment can further include a golfer number 49 and a golfer name 50.

The golfer number 49 can be to uniquely identify the unique information of the golfer 5 (shown in FIG. 1). The golfer number can be a number assigned to each golfer 5 (for example, “0001”, “0002”, . . . ). The golfer number 49 can be entered into the item “golfer number” in the unique information table 43.

The golfer name 50 can be, for example, the name, nickname, or the like of the golfer 5 (shown in FIG. 1). The golfer name 50 can be input to the item “golfer name” in the unique information table 43.

The skill level 45 of the present embodiment can be selected from “beginner,” “intermediate,” and “advanced,” but it is not particularly limited to these. Such skill level 45 can be identified based on predetermined criteria (for example, a handicap, average score, and the like of the golfer 5 (shown in FIG. 1)). The skill level 45 of the present embodiment can be entered in the item “skill level” in the unique information table 43.

The blood type 46 is the blood type of the golfer 5 (shown in FIG. 1). Such blood type 46 can be useful, for example, as a reference for the personality and the like of the golfer 5. The blood type 46 of the present embodiment can be inputted in the item “blood type” of the unique information table 43.

The playing style 47 in the present embodiment can be selected from “aggressive,” “neutral,” and “defensive,” but it is not particularly limited to these. Such playing style 47 may be, for example, directly selected by the golfer 5 (shown in FIG. 1) or may be selected by the computer 3 (shown in FIG. 1) based on the results of a questionnaire to the golfer 5 regarding the playing style. The playing style 47 can be inputted in the item “playing style” of the unique information table 43.

In the carry 48 for each golf club number in the present embodiment, for example, an average value of the carries of the golfer 5 can be input for each number of a golf club 10 (shown in FIG. 1). Each carry 48 is entered in the item “carry for each golf club number” of the unique information table 43.

Although entry of the above-mentioned values may be mandatory for each item of the unique information in the unique information table 43, omission of entry may be permitted in consideration of the case, for example, where the golfer 5 (shown in FIG. 1) is unable to identify the unique information (for example, the carry 48 and the like).

### [Advice Information Storage Part]

The advice information storage part 41B shown in FIG. 3 can be to store the advice information for the golfer 5 (shown in FIG. 1). The advice information storage part 41B of the present embodiment can include an advice information table containing a plurality of pieces of advice information.

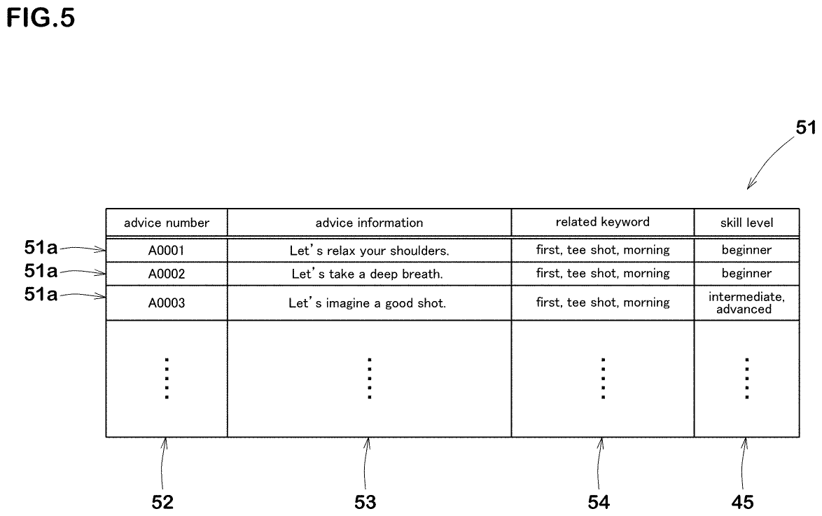

FIG. 5 is a diagram showing the structure of the advice information table 51 of the present embodiment. In the present embodiment, each record (51a) of the advice information table 51 can contain one piece of the advice information 53 entered therein. The items constituting the advice information table 51 of the present embodiment can include, but are not limited to, “advice number,” “advice information,” “related keywords,” and “skill level.”

The advice number 52 can be to uniquely identify the advice information 53. In the present embodiment, each piece of the advice information 53 can be assigned a different advice number 52 (for example, “A0001”, “A0002”, . . . ). The advice number 52 can be entered into the item “advice number” in the advice information table 51.

Each piece of the advice information 53 can be entered as text information in the item “advice information” individually. The advice information 53 of the present embodiment can be related to the mind (mentality) of the golfer 5 shown in FIG. 1.

Examples of the advice information 53 in the present embodiment include “Let's relax your shoulders,” “Let's take a deep breath,” “Let's imagine a good shot,” and so forth. It is possible that such advice information 53 may encourage the nervous golfer 5 (shown in FIG. 1) to relax, for example.

Whether or not the above-described advice information 53 is effective for the golfer 5 (shown in FIG. 1) depends on the situation in which the golfer 5 is playing. For this reason, it may be desirable that the advice information 53 is associated with the situation during play.

In the present embodiment, the situation during play associated with each piece of the advice information 53 can be input as the related keyword 54 in the item “related keyword.” In the item “related keyword,” one related keyword 54 may be entered, or a plurality of the related keywords 54 may be entered.

Examples of the related keyword 54 (keywords indicating the situation during play) include “tee shot,” “first,” “morning,” “bunker shot,” “putt,” and so forth.

Of the above-described advice information 53, “Let's relax your shoulders,” “Let's take a deep breath,” and “Let's imagine a good shot” may all be considered to be effective for the golfer 5 who is going to hit the “first” “tee short” in the “morning.” Therefore, these pieces of the advice information 53 can be associated with “first,” “tee short,” and “morning” among the above-described related keywords 54. These related keywords 54 can be input to the item “related keyword” in the record (51a) in which the associated piece of the advice information 53 is input.

Further, whether or not the advice information 53 is effective for the golfer 5 (shown in FIG. 1) may depend not only on the situation during play but also on the skill level and so forth of the golfer 5, for example. For this reason, the advice information 53 can be associated with the unique information of the golfer 5. The advice information 53 of the present embodiment can be associated with the skill level 45 of the unique information of the golfer 5, but it is not limited to these. The advice information 53 may be associated with, for example, the blood type 46, the playing style 47 of the golfer and the carry 48 for each golf club number shown in FIG. 4.

For the skill level 45, any one of the values (in the present example, “beginner,” “intermediate,” and “advanced”) entered in the item “skill level” in the unique information table 43 can be selected.

The advice information 53 “Let's relax your shoulders” and “Let's take a deep breath” may be considered to be effective for the golfer 5 whose skill level 45 is “beginner.” Therefore, these pieces of the advice information 53 can be associated with “beginner” among the above-described skill levels 45.

On the other hand, it may be difficult for the golfer 5 whose skill level is “beginner” to imagine a good shot. For this reason, the advice information 53 “Let's imagine a good shot” may be associated with “intermediate” and “advanced” among the above-described skill levels 45.

These skill levels 45 can be entered respectively in the item “skill level” in the record (51a) where the associated piece of the advice information 53 is entered.

Further, the degree of tension of the golfer 5 can be considered to be proportional to the magnitude of heart rate. For this reason, the advice information 53 may be associated with the heart rate.

### [Evaluation Storage Part]

The evaluation storage part 41C shown in FIG. 3 can be to store the evaluation on the advice information 53 (shown in FIG. 5) by the golfer 5. The evaluation storage part 41C of the present embodiment can include an evaluation table containing the evaluation on each piece of the advice information 53.

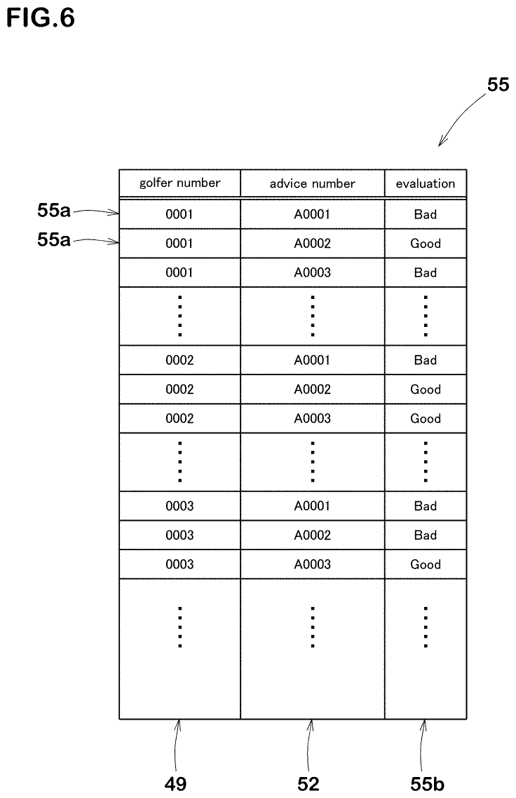

FIG. 6 is a diagram showing the structure of the evaluation table 55 of the present embodiment. In the present embodiment, the evaluation result of one piece of the advice information 53 (shown in FIG. 5) evaluated by one golfer 5 (shown in FIG. 1) can be entered in each record (55a) of the evaluation table 55. The items constituting the evaluation table 55 of the present embodiment can include the “golfer number,” the “advice number,” and “evaluation.”

In the item “golfer number,” the golfer numbers 49 can be entered to identify the golfer 5 (shown in FIG. 1) who evaluated the advice information 53 (shown in FIG. 5). On the other hand, in the item “advice number,” the advice numbers 52 can be entered to identify the piece of the advice information 53 evaluated by the golfer 5.

In the item “evaluation,” an evaluation (55b) evaluated by the golfer 5 (shown in FIG. 1) on the advice information 53 (shown in FIG. 5) can be inputted. The evaluation (55b) of the present embodiment may be either “Good,” which corresponds to “good” or “appropriate,” or “Bad,” which corresponds to “bad” or “ineffective,” and the results of the evaluation are entered in the item “Evaluation.” In the present embodiment, evaluation of the advice information 53 is optional, and if it is not evaluated, an initial value (for example, “Null (blank)”) indicating that the advice information has not been evaluated is entered in the item “evaluation”. In the present embodiment, the advice information 53 can be evaluated in two levels, “Good (appropriate)” and “Bad (ineffective),” but it is not limited to such an embodiment. For example, the advice information 53 may be evaluated in three or more levels, or in five or more levels, so that the advice information 53 can be evaluated in more detail. It should be noted that if evaluation is made in three levels, for example, “Neither” may be added to the above-described two levels of evaluation. Further, if evaluation is made in five levels, for example, “somewhat good” and “somewhat bad” may be added to the above-described three levels of evaluation.

### [Program Portion]

As shown in FIG. 3, the program portion 42 can be a program to execute the information providing method. The program portion 42 can be executed by the arithmetic unit 37. The program portion 42 of the present embodiment can include a unique information input part 42A, a voice information analyzing part 42B, an advice information identification part 42C, an advice information output part 42D, an evaluation input part 42E, and an end determination part 42F. These functions of the program portion will be described in each step of the information providing method described below.

### Golfer-Oriented Information Providing Method (First Embodiment)

Next, the processing procedure of the information providing method of the present embodiment will be described. The information providing method of the present embodiment can be initiated by the operation of the portable terminal 2 by the golfer 5 shown in FIG. 1, which can cause the program portion 22 (the information providing part 22A and the information output part 22B) shown in FIG. 2 to be loaded into the working memory 19 and executed by the arithmetic unit 17. It should be noted that the procedure for starting the information providing method is not limited to such an embodiment.

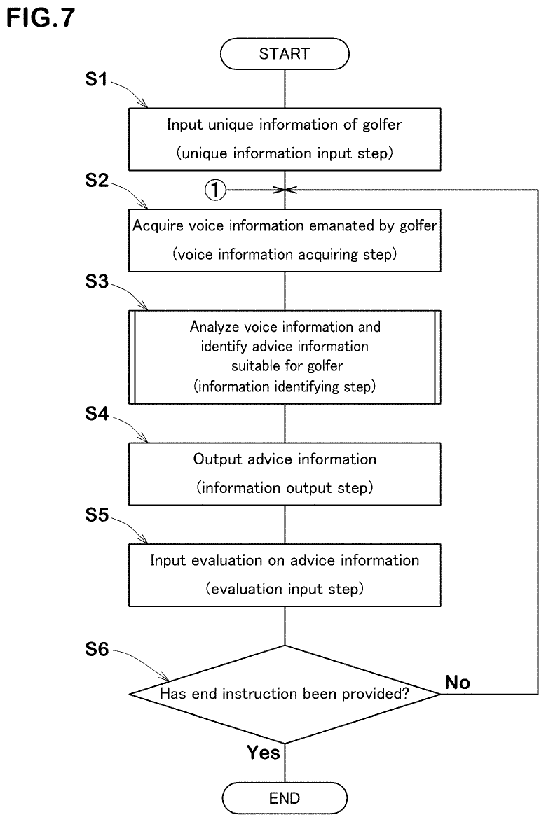

In the present embodiment, a signal (data) indicating that the processing of the information providing method has started can be transmitted from the portable terminal 2 shown in FIG. 1 to the computer 3 via the communication network 4. FIG. 7 is a flowchart showing the processing procedure of the golfer-oriented information providing method to the golfer 5 in the present embodiment.

### [Unique Information Input Step]

In the information providing method of the present embodiment, first, the unique information of the golfer 5 (FIG. 1) can be input (unique information input step S1). In the present embodiment, the unique information of the golfer 5 can be input by the golfer 5 operating the portable terminal 2. Then, the input unique information can be transmitted to the computer 3 and entered (registered) in the unique information table 43 shown in FIG. 4.

In the unique information input step S1 of the present embodiment, first, the unique information input part 42A in the computer 3 shown in FIG. 3 can be read into the working memory 39. Then, the unique information input part 42A can be executed by the arithmetic unit 37, so that the computer 3 functions to input the unique information of the golfer 5.

In the present embodiment, the computer 3 shown in FIG. 1 can transmit the signal to the portable terminal 2 via the communication network 4 to cause the display 16 of the portable terminal 2 shown in FIG. 3 display a unique information input screen.

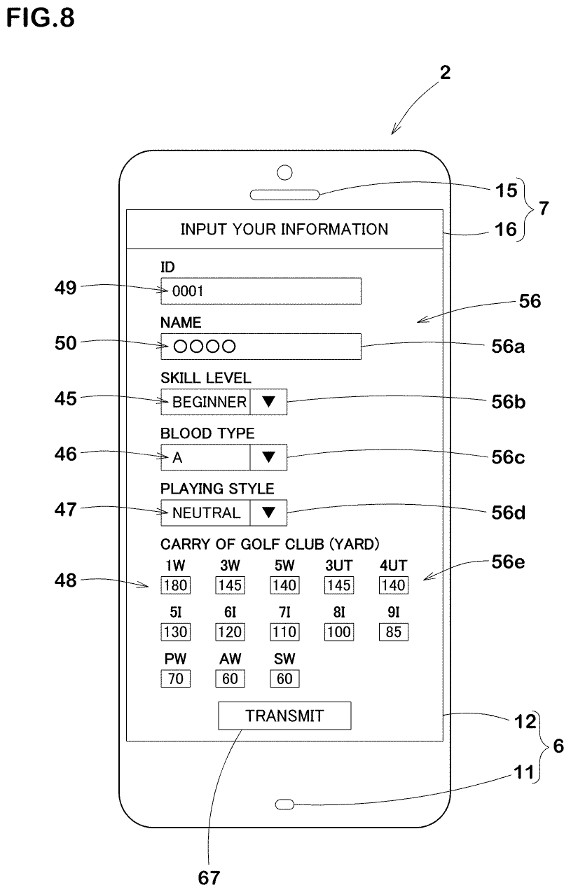

FIG. 8 is a diagram showing the unique information input screen 56 of the present embodiment. The unique information input screen 56 can let the golfer 5 input the unique information. The unique information input screen 56 can be displayed on the display 16 by the information output part 22B in the portable terminal 2 executed by the arithmetic unit 17 based on the signal from the computer 3.

The unique information input screen 56 of the present embodiment can include a golfer name input section (56a), a skill level input section (56b), a blood type input section (56c), a playing style input section (56d), and a carry input section (56e).

The golfer name input section (56a) can be to input the golfer name (name of the golfer 5) 50. In the golfer name input section (56a), the name, nickname, or the like of the golfer 5 (shown in FIG. 1) can be directly input by using, for example, a language input system (Input Method Editor) of the portable terminal 2.

The skill level input section (56b) can be to input the skill level 45 of the golfer 5 (shown in FIG. 1). The blood type input section (56c) can be to input the blood type 46 of the golfer 5. The playing style input section (56d) can be to input the playing style 47 of the golfer 5. In the skill level input section (56b) to the playing style input section (56d) of the present embodiment, a value can be selectively inputted from the above-described values by way of, for example, a pull-down menu or the like, but may be directly input by using the language input system installed on the portable terminal 2.

The carry input section (56e) can be to input the carry 48 for each golf club number. The carry input section (56e) of the present embodiment can be configured so that the carry 48 can be input for each golf club number, for example, directly by using the language input system.

On the unique information input screen 56 of the present embodiment, the golfer number (ID) 49 can be displayed. The golfer number 49 of the present embodiment can be automatically assigned by the computer 3, but may be directly entered by the golfer 5 under the restriction that the number does not overlap with other golfers 5.

In the unique information input step S1 of the present embodiment, the unique information entered by the golfer 5 (shown in FIG. 1) can be transmitted to the computer 3 (shown in FIG. 1) by the golfer 5 pressing a transmission button 67 displayed on the unique information input screen 56. Then, the unique information can be received by the computer 3, and the record (43a) including the unique information of the golfer 5 is registered in the unique information table 43 shown in FIG. 4.

In the unique information input step S1, for the golfer 5 who has already input the unique information into the unique information table 43, for example, a login screen (not shown) may be displayed to let the golfer 5 input the golfer number (ID) 49, a password (not shown), and so forth. This can allow the computer 3 to obtain the unique information of the golfer 5 from the unique information table 43 based on the golfer number 49. That is, in the case of using the information providing system 1 of the present embodiment, the unique information input step S1 may only need to be operated once as long as there is no change in the unique information.

### [Voice Information Acquiring Step]

Next, in the information providing method of the present embodiment, voice information emanated by the golfer 5 shown in FIG. 1 can be acquired by the portable terminal 2 (voice information acquiring step S2). In the present embodiment, the information providing part 22A in the portable terminal 2 shown in FIG. 2 can be executed by the arithmetic unit 17 to cause the portable terminal 2 to function as a means of acquiring the voice information emanated by the golfer 5.

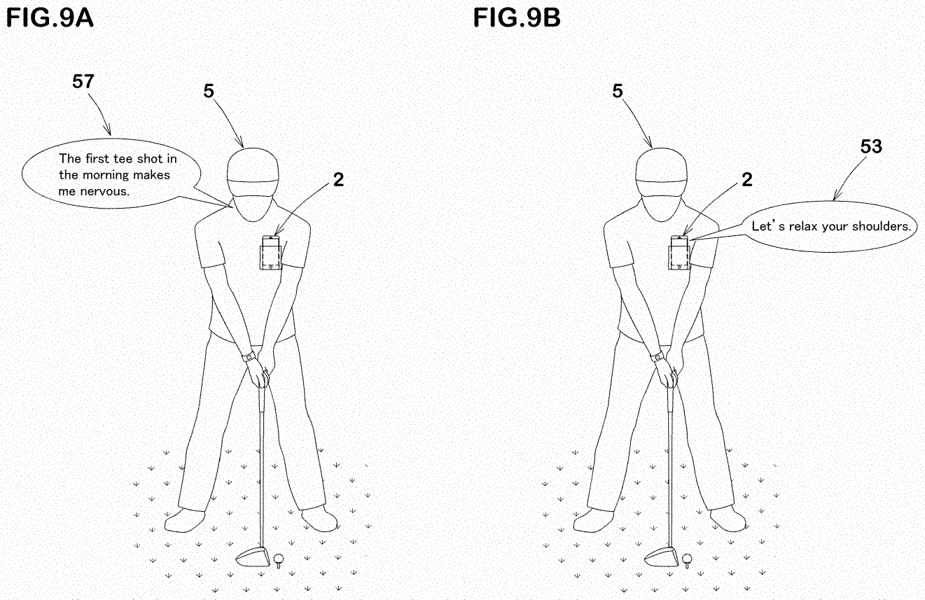

FIG. 9A is a diagram showing a state in which the golfer 5 emanates the voice information 57. In the voice information acquiring step S2 of the present embodiment, the voice information 57 emanated by the golfer 5 can be input from the microphone 11 (shown in FIG. 2 and FIG. 8). Then, the input voice information 57 can be transmitted (provided) to the computer 3 via the communication network 4 shown in FIG. 1. This can allow the computer 3 to acquire the voice information 57 emanated by the golfer 5.

In the present embodiment, it can be that the execution of the next information identifying step S3 is put on hold until the golfer 5 emanates the voice information 57. The determination as to whether the golfer has emanated the voice information 57 can be made based on the magnitude of the sound pressure level of the acquired voice information 57 or the like, for example. This can prevent noise emanated from the surrounding of the golfer 5 from being acquired as the voice information 57 emanated by the golfer 5. The acquired voice information 57 can be stored in the working memory 39 of the computer 3 shown in FIG. 3.

### [Information Identifying Step]

Next, in the information providing method of the present embodiment, a piece of the advice information suitable for the golfer 5 (shown in FIG. 9A) can be identified (information identifying step S3). The information identifying step S3 of the present embodiment can be carried out by the computer 3 that has been provided with the voice information 57.

In the present embodiment, as shown in FIG. 3, the advice information identification part 42C of the computer 3 can be read into the working memory 39. Then, the advice information identification part 42C can be executed by the arithmetic unit 37 so that the computer 3 functions to specify pieces of the advice information suitable for the golfer 5.

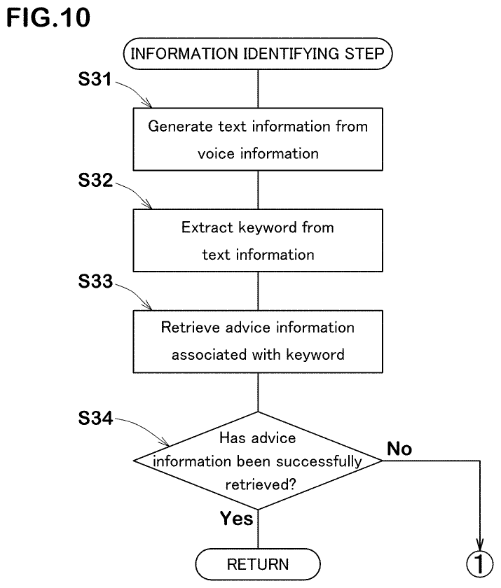

In the information identifying step S3 of the present embodiment, the voice information 57 (shown in FIG. 9A) can be analyzed, and a piece of the advice information 53 suitable for the golfer 5 can be specified and selected from the advice information table 51 containing the plurality of pre-recorded pieces of the advice information 53 shown in FIG. 5. FIG. 10 is a flowchart showing the processing procedure of the information identifying step S3 of the present embodiment.

[Generation of Text information]

In the information identifying step S3 of the present embodiment, first, text information can be generated from the voice information 57 (shown in FIG. 9A) (step S31). Generation of the text information from the voice information 57 can be carried out as appropriate. In the present embodiment, publicly known voice recognition software which can convert voice information into text information can be used.

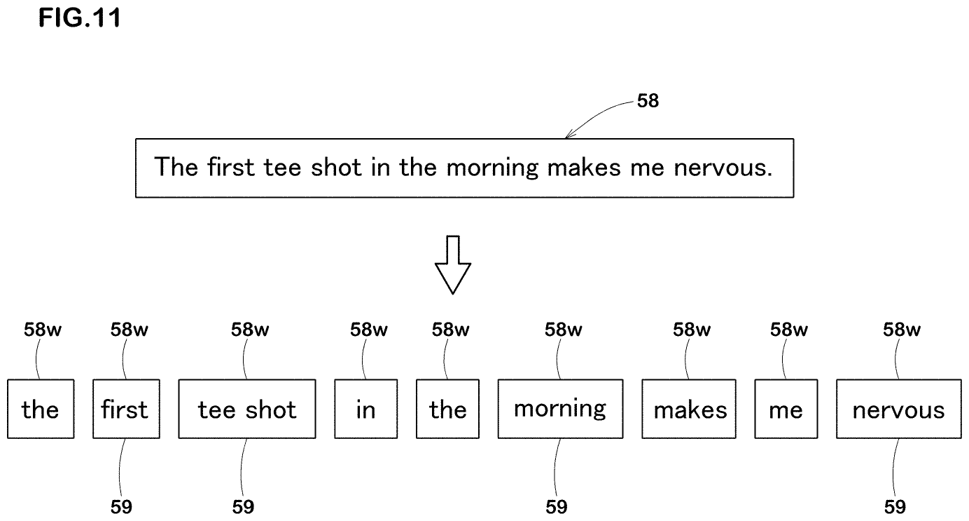

In the present embodiment, the voice recognition software can be included in the advice information identification part 42C shown in FIG. 3. Therefore, in step S31, the computer 3 can generate text information from the voice information 57 by executing the advice information identification part 42C by the arithmetic unit 37. FIG. 11 is a diagram illustrating an example of the text information 58 (the voice information 57) and keywords 59. The text information 58 can be stored in the working memory 39.

### [Extraction of Keywords]

Next, in the information identifying step S3 of the present embodiment, one or a plurality of keywords 59 can be extracted from the text information (step S32). Extraction of the keywords 59 can be carried out as appropriate. In the present embodiment, publicly known natural language processing software capable of performing the morphological analysis for dividing the text information 58 into words, the syntactic analysis, and the like can be used.

In the present embodiment, natural language processing software can be included in the advice information identification part 42C shown in FIG. 3. Therefore, in step S32, it is possible that the computer 3 can divide the text information 58 into a plurality of words (58w) and extract the keywords 59 by executing the advice information identification part 42C by the arithmetic unit 37.

In step S32 of the present embodiment, as shown in FIG. 11, when the text information 58 (voice information 57) is “The first tee shot in the morning makes me nervous,” the text information 58 can be divided into words (58w) such nouns, verbs, adjectives, articles, prepositions, and so forth, including “the,” “first,” “tee shot,” “in,” “the,” “morning,” “makes,” “me,” and “nervous.” Next, in step S32, the words (58w) not eligible for the keywords such as articles, prepositions, and so forth (for example, “the” and “in”) can be removed, and the other words (58w) (for example, “first,” “tee shot,” and “nervous”) can be extracted as the keywords 59.

In step S32, among the words (58w) extracted as the keywords 59, the words (58w) that may not affect the identification of the advice information 53 may be further excluded. It should be noted that such exclusion of the words (58w) can be carried out as appropriate. For example, a plurality of words related to the advice information 53 may be registered in advance and the words (58w) extracted as the keyword 59 may be excluded when they do not correspond to any of the registered words. The extracted one or more keywords 59 can be stored in the working memory 39 (shown in FIG. 3).

### [Search for Advice Information]

Next, in the information identifying step S3 of the present embodiment, a piece or a plurality of pieces of the advice information 53 associated with the keywords 59 can be searched in the advice information table 51 (shown in FIG. 5) (step S33). In the present embodiment, in the advice information table 51, the record (51a) in which at least one of the extracted keywords 59 can be included in the related keyword (keyword related to the situation during play) 54 can be selected. Then, the piece of the advice information 53 of the selected record (51a) is retrieved (identified).

As shown in FIG. 11, the keywords 59 extracted in the present embodiment are “first,” “tee shot,” “morning,” and “nervous.” In the present embodiment, in the advice information table 51 shown in FIG. 5, the records (51a) in which at least one of the extracted keywords 59 can be included or partially matches the related keywords 54 are selected. Then, the pieces of the advice information 53 of the selected records (51a) (“Let's relax your shoulders,” “Let's take a deep breath,” and “Let's imagine a good shot”) can be retrieved (specified).

In the present embodiment, a plurality of pieces of the advice information 53 can be specified, i.e., “Let's relax your shoulders,” “Let's take a deep breath,” and “Let's imagine a good shot.” It should be noted that when a plurality of pieces of the advice information 53 can be specified as in the present embodiment, it may be limited to any piece of the advice information 53.

It should be noted that the extracted keywords 59 (shown in FIG. 11) may not always match the related keywords (situation during play) 54 entered in the advice information table 51. For this reason, in step S33, a learning model generated by deep learning (deep machine learning) using artificial intelligence (AI), for example, may be used to more reliably associate the extracted keywords 59 with the related keywords 54.

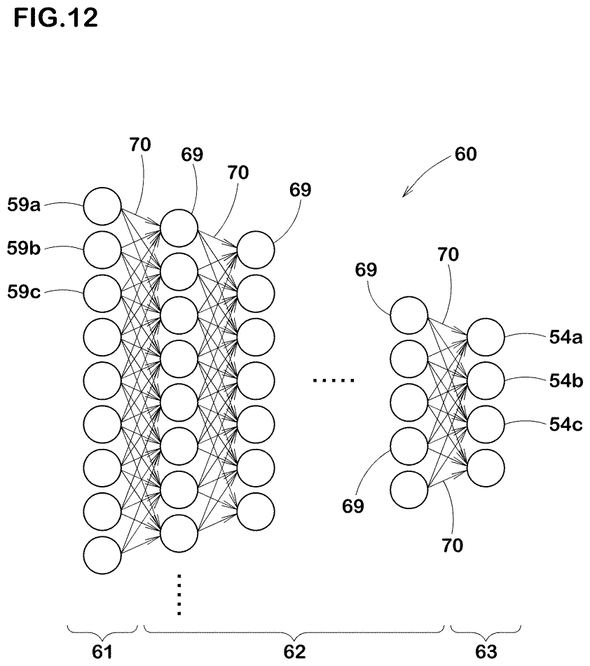

FIG. 12 is a diagram showing an example of a learning model 60. The learning model 60 can be defined by an input layer 61, an output layer 63, and an intermediate layer (hidden layer) 62. The input layer 61 can include various keywords (59a), (59b), (59c), . . . predicted to be emanated by the golfer 5 (shown in FIG. 9A). The output layer 63 can include the related keywords (for example, “tee shot,” “bunker shot,” and so forth) (54a), (54b), (54c), . . . . The intermediate layer 62 can be generated by machine learning.

The keywords (59a), (59b), (59c), . . . in the input layer 61 can be each linked to one of the related keywords (54a), (54b), (54c), . . . in the output layer 63 based on, for example, various situations during play and the like of the golfer 5 (shown in FIG. 9A). In other words, the keywords (59a), (59b), (59c), . . . can be stored in a state in which each of them is linked to one of the related keywords (54a), (54b), (54c), . . . , and can be used as teacher data for deep learning.

The intermediate layer 62 can include a multi-level hierarchy of combinations of a plurality of neurons (nodes) 69 and optimized weighting coefficients 70 (parameters). Each neuron 69 can be connected by the weighting coefficients 70. The intermediate layer 62 configured as such can be referred to as a neural network. In other words, the learning model 60 of the present embodiment can include a neural network.

The weighting coefficients 70 can be learned by adjusting the respective weighting coefficient 70 for each neuron so as to decrease the difference between the output and the true output (teacher data) with respect to the input. Such a learning method can be referred to as the error backpropagation method (backpropagation). With each neuron 69 and each weighting coefficient 70 being determined, the learning model 60 can be generated.

In step S33 of the present embodiment, by using the learning model 60, it can be possible that the related keywords (situation during play) 54 are more reliably selected from the combinations of the plurality of extracted keywords 59. As a result, in the information identifying step S3, it can be possible that pieces of the advice information 53 suitable for the golfer 5 are more reliably identified from the advice information table 51 containing a plurality of pieces of the advice information 53 shown in FIG. 5.

Further, as described above, whether or not the advice information 53 can be effective for the golfer 5 depends also on the skill level and the like of the golfer 5. Therefore, in step S33, from the plurality of pieces of the advice information 53, pieces of the advice information 53 associated with the unique information of the golfer 5 may be identified preferentially.

As shown in FIG. 4, the skill level 45 in the unique information of the golfer 5 in the present embodiment (the golfer whose golfer number 49 is “0001”) can be “beginner.” On the other hand, as shown in FIG. 5, the pieces of the advice information 53 “Let's relax your shoulders” and “Let's take a deep breath” have the skill level 45 of “beginner,” while the skill level 45 of “Let's imagine a good shot” can be “intermediate” and “advanced.” Therefore, in step S33, it can be that “Let's relax your shoulders” and “Let's take a deep breath” associated with the skill level 45 of “beginner” can be identified preferentially as the advice information 53.

Further, when the advice information 53 is associated with the blood type 46, the playing style 47, and the carry 48 for each golf club number of the unique information of the golfer 5, the advice information 53 may be preferentially identified based on the above unique information. Furthermore, when the advice information 53 is associated with the heart rate of the golfer 5, the advice information 53 may be preferentially identified based on the heart rate acquired from the activity tracker 13 (shown in FIG. 1 and FIG. 2).

As described above, in the information identifying step S3 of the present embodiment, it can be possible that one piece of the advice information 53 suitable for the golfer 5 is specified from the advice information table 51 containing a plurality of pieces of the advice information 53.

In the present embodiment, “Let's relax your shoulders” can be identified from “Let's relax your shoulders” and “Let's take a deep breath” retrieved as the advice information 53. The identified piece of the advice information 53 can be stored in the working memory 39 (shown in FIG. 3) of the computer 3.

[Determination as to Whether Retrieval has been Made (when Retrieval has been Successfully Made)]

Next, in the information identifying step S3 of the present embodiment, it can be determined whether or not one or more pieces of the advice information 53 have been retrieved (step S34). If it is determined in step S34 that one or more pieces of the advice information 53 have been successfully retrieved (“Yes” in step S34), a series of processes in the information identifying step S3 can be completed, and the next information output step S4 (shown in FIG. 7) is carried out.

### [Information Output Step]

Next, in the information providing method of the present embodiment, as shown in FIG. 7, the piece of the advice information 53 specified in the information identifying step S3 can be output from the portable terminal 2 in a manner perceptible to the golfer 5 (information output step S4).

In the information output step S4, first, the advice information output part 42D stored in the computer 3 shown in FIG. 3 can be read into the working memory 39. Then, the advice information output part 42D can be executed by the arithmetic unit 37 to make the computer 3 function to output the advice information 53.

FIG. 9B is a diagram illustrating a state in which the advice information 53 is outputted from the portable terminal 2. In the information output step S4 of the present embodiment, the identified piece of the advice information 53 can be transmitted from the computer 3 shown in FIG. 1 to the portable terminal 2 via the communication network 4. Next, in the information output step S4, the information output part 22B in the portable terminal 2 shown in FIG. 2 can be executed by the arithmetic unit 17. Thereby, in the information output step S4, as shown in FIG. 9B, it can be possible that the transferred piece of the advice information 53 is output as the voice information perceivable by the golfer 5 through the speaker 15 (shown in FIG. 2). Therefore, in the information output step S4, it can be possible that the advice information 53 is provided to the golfer 5.

In the information providing method (information providing system 1) of the present embodiment, as shown in FIG. 9A and FIG. 9B, it can be possible that a piece of the advice information 53 suitable for the golfer 5 is identified based on the voice information 57 emanated by the golfer 5 and can be output from the portable terminal 2 in a manner perceptible to the golfer 5. Therefore, according to the information providing method (information providing system 1) of the present embodiment, it can be possible that useful information suitable for the golfer 5 is provided in various situations during golf play without requiring the golfer 5 to perform special operation (such as imputing text and the like, for example).

[Determination as to Whether Retrieval has been Made (when Retrieval has not been Successfully Made)]

As shown in FIG. 10, when it is determined that one or more pieces of the advice information 53 have not been successfully retrieved (“No” at step S34) in step S34 of the information identifying step S3 in the present embodiment, the voice information acquiring step S2 (shown in FIG. 7) can be performed. As described above, in the voice information acquiring step S2 of the present embodiment, the execution of the next information identifying step S3 can be put on hold until the golfer 5 emanates the voice information 57. It should be noted that a step of outputting voice information asking about the situation during play (for example, “How is your play going?,” “How is the wind?,” and the like) may be carried out between step S34 and the voice information acquiring step S2. Further, a playing situation input step may be performed to have the golfer input the situation during play. In this case, in the information identifying step S3, it can be that a piece of the advice information associated with the situation during play is specified preferentially from the plurality of pieces of the advice information 53.

### [Evaluation Input Step]

Next, in the information providing method of the present embodiment, as shown in FIG. 7, after the information output step S4, the evaluation (55b) on the piece of the advice information 53 by the golfer 5 shown in FIG. 9B can be input (evaluation input step S5). In the evaluation input step S5, as shown in FIG. 3, the evaluation input part 42E of the computer 3 can be first read into the working memory 39. Then, the evaluation input part 42E can be executed by the arithmetic unit 37 so as to cause the computer 3 to input the evaluation (55b) on the advice information 53.

In the evaluation input step S5 of the present embodiment, after outputting the advice information 53 (shown in FIG. 9B), the computer 3 shown in FIG. 1 can transmit a signal to the portable terminal 2 via the communication network 4. Then, an evaluation input screen can be displayed on the display 16 (shown in FIG. 2 and FIG. 8) of the portable terminal 2.

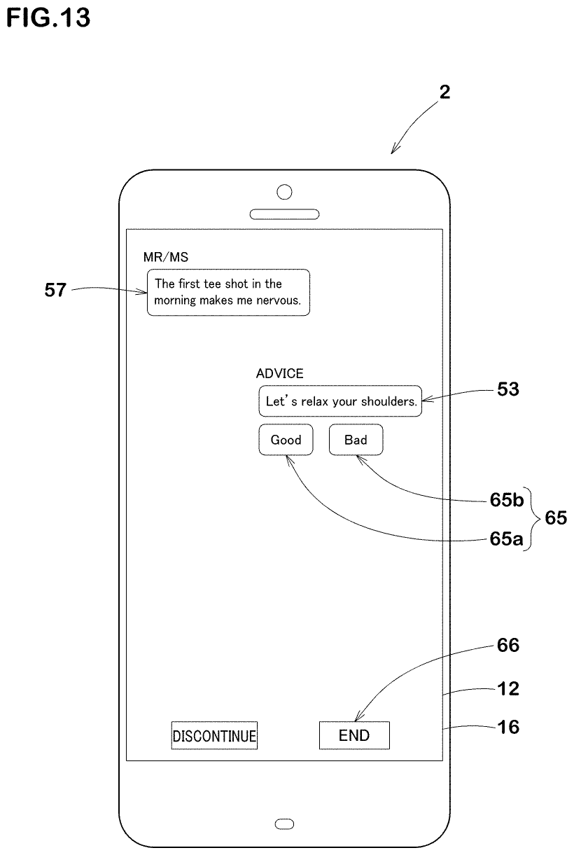

FIG. 13 is a diagram showing an evaluation input screen 64 of the present embodiment. The evaluation input screen 64 can allow the golfer 5 to input an evaluation on the pieces of the advice information 53. The display of the evaluation input screen 64 can be performed by the information output part 22B stored in the portable terminal 2 shown in FIG. 3 being executed by the arithmetic unit 17.

The evaluation input screen 64 of the present embodiment can include the voice information 57 from the golfer, the outputted piece of the advice information 53, and evaluation buttons 65 for the advice information 53. The evaluation buttons 65 can include a first button (“Good” button) (65a) and a second button (“Bad” button) (65b). The first button (65a) can be to be pressed when the golfer 5 determines that the outputted piece of the advice information 53 is “good” or “appropriate.” On the other hand, the second button (65b) can be pressed when the golfer 5 determines that the outputted piece of the advice information 53 is “bad” or “ineffective.”

When the first button (65a) is pressed, the golfer number 49 (“0001” in the present example) of the golfer 5 who made the evaluation, the advice number 52 (“A0001” in the present example) corresponding to the piece of the advice information 53, and the evaluation (55b) (“Good”) can be transmitted to the computer 3 (FIG. 1). Then, these pieces of information can be received by the computer 3, and the record (55a) including the evaluation (55b) on the piece of the advice information 53 by the golfer 5 can be registered in the evaluation table 55 shown in FIG. 6.

On the other hand, when the second button (65b) is pressed, in a procedure similar to when the first button (65a) is pressed, the record (55a) containing the evaluation (55b) (“Bad”) on the piece of the advice information 53 by the golfer 5 can be registered in the evaluation table 55 shown in FIG. 6. It should be noted that if the piece of the advice information 53 has already been evaluated, the evaluation may be updated to a new evaluation.

In the information providing method of the present embodiment, with the evaluation on the piece of the advice information 53 by the golfer 5 being inputted, it can be possible that the output piece of the advice information 53 is fed back based on that evaluation. Thereby, in the subsequent information identifying step S3, it can be possible that pieces of the advice information 53 preferred by the golfer 5 are identified based on the evaluation by the golfer 5.

### [End Determination Step]

Next, in the information providing method of the present embodiment, it can be determined whether or not an instruction to end the information providing method has been provided (step S6). In step S6 of the present embodiment, the end determination part 42F stored in the computer 3 shown in FIG. 3 can be read into the working memory 39 and executed by the arithmetic unit 37 so that the computer 3 is caused to determine whether an end instruction has been provided or not.

In the present embodiment, for example, with an end button 66 displayed on the display 16 shown in FIG. 13 being pressed by the golfer 5, the instruction to end can be provided. Further, the instruction to end may be provided based on the voice information (voice information regarding an end instruction) emanated by the golfer 5.

If it is determined in step S6 that an end instruction has been provided (“Yes” in step S6), a series of processes of the information providing method is completed. On the other hand, if it is determined in step S6 that an end instruction has not been provided (“No” in step S6), the voice information acquiring step S2 through step S6 can be performed again. Therefore, it can be possible that the information providing method of the present embodiment continuously provides useful information (the advice information 53) suitable for the golfer 5 shown in FIG. 9B until an end instruction is provided (during play).

In the information providing method of the present embodiment, in the information identifying step S3 performed after the evaluation input step S5, it can be that highly-evaluated piece of the advice information (the advice information evaluated as “Good”) 53 can be identified preferentially from the plurality of pieces of the advice information 53.

In step S33 of the present embodiment, when a plurality of pieces of the advice information 53 are retrieved, first, based on the advice numbers 52 (shown in FIG. 5) of their records (51a), the evaluations (55b) of these pieces of the advice information 53 can be identified from the evaluation table 55 shown in FIG. 6. Then, from among these pieces of the advice information 53, highly-evaluated piece of the advice information 53 (evaluated as “Good”) can be preferentially identified.

In this manner, in the information providing method of the present embodiment, it can be possible that the highly-evaluated piece of the advice information 53 is provided based on the evaluation on the advice information 53 by the golfer 5. Therefore, it can be possible that the information providing method provides pieces of the advice information 53 more suitable for the golfer 5 (preferred by the golfer 5).

In step S33, if an unfavorable (evaluation is “Bad”) piece of advice information 53 has been retrieved, it can be possible that another piece of the advice information 53 not evaluated as “Bad” is searched for again to retrieve. Thus, in the information providing method of the present embodiment, it can be possible that pieces of the advice information 53 not preferred by the golfer 5 can be prevented from being outputted.

### Golfer-Oriented Information Providing Method (Second Embodiment)

In the information providing method of the embodiment described above, the advice information 53 regarding mind (mentality) of the golfer 5 can be provided. However, it is not limited to such an embodiment. For example, the advice information 53 regarding the shot (skill) of the golfer 5 may be provided.

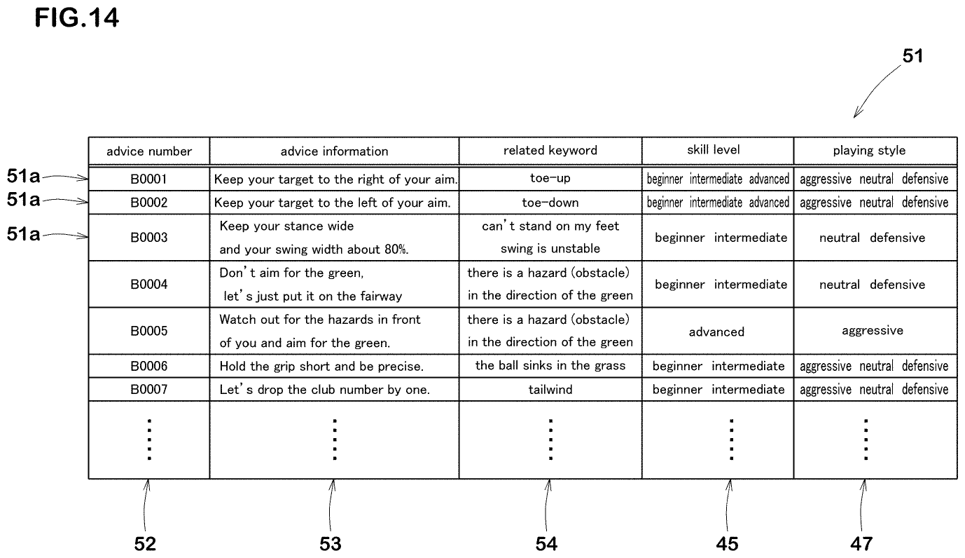

FIG. 14 is a diagram showing the structure of the advice information table 51 of another embodiment of the present disclosure. In this embodiment, the same reference sign can be assigned to the same configuration as that of the embodiment described above, and description thereof may be omitted.

Items constituting the advice information table 51 of the present embodiment can include “advice number,” “advice information,” “related keywords,” “skill level,” and “playing style,” but the items are not limited to these.

The advice information 53 of this embodiment can include the following, for example. These pieces of the advice information 53 can be related to the shot (skill) of the golfer 5.

Keep your target to the right of your aim.

Keep your target to the left of your aim.

Keep your stance wide and your swing width about 80%.

Don't aim for the green, let's just put it on the fairway.

Watch out for the hazards in front of you and aim for the green.

Hold the grip short and be precise.

Let's drop the club number by one.

Whether or not the above-described advice information 53 is effective for the golfer 5 (shown in FIG. 9B) may depend on the situation during play of the golfer 5 (for example, lie, target carry, wind strength, and so forth). Therefore, it can be that the advice information 53 is associated with the situation during play. In this embodiment, it can be that the situation during play to be associated with the advice information 53 includes at least one of lie, target carry, and wind strength.

In this embodiment, as with the embodiment described above, the situation during play associated with each piece of the advice information 53 can be inputted in the item “related keywords” as the related keyword 54.

Examples of the related keyword 54 include “toe-up,” “toe-down,” “can't stand on my feet,” “swing is unstable,” “there is a hazard (obstacle) in the direction of the green,” “the ball sinks in the grass,” “tailwind,” and so forth.

The piece of the advice information 53 of “Keep your target to the right of your aim” can be considered to be effective for the golfer 5 who is in a tow-up standing position as a lie situation. Therefore, among the above-described related keywords 54, “toe-up” can be associated with this piece of the advice information 53.

The piece of the advice information 53 of “Keep your target to the left of your aim” can be considered to be effective for the golfer 5 who is in a tow-down standing position as a lie situation. Therefore, among the above-described related keywords 54, “toe-down” can be associated with this piece of the advice information 53.

The piece of the advice information 53 of “Keep your stance wide and your swing width about 80%” can be considered to be effective for the golfer 5 who cannot stand his/her feet at the standing position and for the golfer 5 whose swing at the standing position is unstable as a lie situation. Therefore, this piece of the advice information 53 can be associated with “can't stand on my feet” and “swing is unstable” among the above-described related keywords 54.

The pieces of the advice information 53 of “Don't aim for the green, let's just put it on the fairway” and “Watch out for the hazards in front of you and aim for the green” can be considered to be effective for a situation in which there is a hazard (obstacle), such as a tree, bunker, or pond, in the direction of the green as a lie situation. Therefore, among the above-described related keywords 54, “there is a hazard (obstacle) in the direction of the green” can be associated with these pieces of the advice information 53.

The piece of the advice information 53 of “Hold the grip short and be precise” can be considered to be effective for the golfer 5 whose ball sinks in the grass as a lie situation. Therefore, among the above-described related keywords 54, “the ball sinks” can be associated with this piece of the advice information 53.

The piece of the advice information 53 of “Let's drop the club number by one” can be considered to be effective for the golfer 5 who has a strong tailwind (following wind) in her/his position. Therefore, of the above-described related keywords 54, “tailwind” can be associated with this piece of the advice information 53.

These related keywords 54 can be entered in the item “related keywords” in the record (51a) having the associated pieces of the advice information 53 entered therein. It should be noted that the above-described association of the related keywords 54 is not limited such an embodiment.

Further, whether or not the advice information 53 is effective for the golfer 5 may depend not only on the situation during play but also on, for example, the skill level, playing style, and so forth of the golfer 5. Thus, it can be that the advice information 53 is associated with the unique information of the golfer 5. The advice information 53 of the present embodiment can be associated with the skill level 45 and the playing style 47 among the unique information of the golfer 5, but it is not limited to such an embodiment. The advice information 53 may be associated with the blood type 46 of the golfer and the carry 48 for each golf club number, for example.

For the skill level 45, one of the values (“beginner,” “intermediate,” and “advanced” in the present example) to be input in the item “skill level” of the unique information table 43 can be selected.

The pieces of the advice information 53 of “Keep your target to the right of your aim” and “Keep your target to the left of your aim” can be considered to be effective for the golfer 5 at any skill level. Therefore, these pieces of the advice information 53 are associated with all skill levels 45 (“beginner,” “intermediate,” and “advanced”).

The pieces of the advice information 53 of “Keep your stance wide and your swing width about 80%” and “Don't aim for the green, let's just put it on the fairway” can be considered to be effective for the golfer 5 whose skill level 45 is either “beginner” or “intermediate” compared with the “advanced” golfer 5. Therefore, these pieces of the advice information 53 can be associated with “beginner” and “intermediate” of the above-described skill levels 45.

If the piece of the advice information 53 of “Watch out for the hazards in front of you and aim for the green” is provided to the golfer 5 whose skill level 45 is either “beginner” or “intermediate,” it may be difficult to expect an effective play. Therefore, this piece of the advice information 53 can be associated with “advanced” of the above-described skill levels 45.

The pieces of the advice information 53 of “Hold the grip short and be precise” and “Let's drop the club number by one” can be considered to be effective for the golfer 5 whose skill level 45 is either “beginner” or “intermediate” compared with the “advanced” golfer 5. Therefore, these pieces of the advice information 53 can be associated with “beginner” and “intermediate” of the above-described skill levels 45.

These skill levels 45 can be inputted in the item “skill level” in the record (51a) having the associated pieces of the advice information 53 inputted therein. It should be noted that the above-described association of the skill levels 45 is not limited to such an embodiment.

For the playing style 47, any of the values (“aggressive,” “neutral,” and “defensive” in the present example) to be input in the item “playing style” of the unique information table 43 can be selected.

The pieces of the advice information 53 of “Keep your target to the right of your aim” and “Keep your target to the left of your aim” can be considered to be effective for any golfer 5 irrespective of the playing style. Therefore, these pieces of the advice information 53 can be associated with all playing styles 47 (“aggressive,” “neutral,” and “defensive”).

The piece of the advice information 53 of “Keep your stance wide and your swing width about 80%” can be considered to be effective for the golfer 5 whose playing style 47 is either “neutral” or “defensive” compared with the golfer 5 whose playing style 47 is “aggressive.” Similarly, the piece of the advice information 53 of “Don't aim for the green, let's just put it on the fairway” can be considered to be also effective for the golfer 5 whose playing style 47 is either “neutral” or “defensive.” Therefore, these pieces of the advice information 53 can be associated with “neutral” and “defensive” of the above-described playing styles 47.

The piece of the advice information 53 of “Watch out for the hazards in front of you and aim for the green” can be considered to be effective for the golfer 5 whose playing style 47 is “aggressive” compared with the golfer 5 whose playing style 47 is either “neutral” or “defensive.” Therefore, this piece of the advice information 53 can be associated with “aggressive” of the above-described playing styles 47.

The pieces of the advice information 53 of “Hold your grip short and hit accurately” and “Let's drop the club number by one” can be considered to be effective for any golfer 5 irrespectively of the playing style. Therefore, these pieces of the advice information 53 can be associated with all playing styles 47 (“aggressive,” “neutral,” and “defensive”).

These playing styles 47 can be entered into the item “playing style” in the record (51a) having the associated pieces of the advice information 53 entered therein. It should be noted that the above-described association of the playing styles 47 is not limited to such an embodiment.

In step S33 of this embodiment, in the advice information table 51, the record (51a) in which at least one of the keywords 59 extracted from the text information 58 (voice information 57) shown in FIG. 11 is included in the related keywords 54 can be selected. Then, the piece of the advice information 53 (“Keep your target to the right of your aim” or the like, for example) of the selected record (51a) can be retrieved (identified).

It should be noted that in step S33, the keyword 59 extracted from the voice information of the golfer 5 and the related keyword (situation during play) 54 input in the advice information table 51 may not always match. Thus, in step S33 of retrieving pieces of the advice information 53, it can be that the learning model 60 (shown in FIG. 12) generated by deep learning can be used in order to more reliably associate the extracted keywords 59 with the related keywords 54.

In the learning model 60, various keywords (regarding the shot) predicted to be emanated by the golfer 5 (shown in FIG. 9A) can be set in the respective keywords (59a), (59b), (59c), . . . of the input layer 61. Examples of the keywords include “toe,” “up,” “down,” “rough,” “can't stand on my feet,” “swing,” “unstable,” “green,” “there is a hazard (obstacle),” “grass,” “sink,” “tailwind,” “headwind,” “tough,” and so forth. The above-described related keywords 54 can be set in the respective related keywords (54a), (54b), . . . of the output layer 63.

In step S33 of this embodiment, with the use of the learning model 60, it can be possible that the related keywords (situation during play) 54 may be more reliably selected from the combinations of the plurality of the extracted keywords 59. Therefore, in the information identifying step S3, it can be possible that a piece of the advice information 53 suitable for the golfer 5 (shown in FIG. 9B) may be more reliably identified from the advice information table 51 including the plurality of pieces of the advice information 53.

Further, as described above, whether or not the advice information 53 is effective for the golfer 5 (shown in FIG. 9B) may depend also on the skill level, play stance, and so forth of the golfer 5. Thus, in step S33, from the plurality of pieces of the advice information 53, pieces of the advice information 53 associated with the unique information of the golfer 5 may be identified preferentially.

As shown in FIG. 14, the piece of the advice information 53 “Don't aim for the green, let's just put it on the fairway” can have the skill level 45 of “beginner” and “intermediate.” On the other hand, the piece of the advice information 53 “Watch out for the hazards in front of you and aim for the green” can have the skill level 45 of “advanced.” When these pieces of the advice information 53 are retrieved for the golfer 5 whose skill level 45 is “beginner,” it can be that “Don't aim for the green, let's just put it on the fairway” can be identified preferentially as the advice information 53.

The playing style 47 of the piece of the advice information 53 “Don't aim for the green, let's just put it on the fairway” can be “neutral” and “defensive.” On the other hand, the playing style 47 of “Watch out for the hazards in front of you and aim for the green” can be “aggressive.” When these pieces of the advice information 53 are retrieved for the golfer 5 whose playing style 47 is “neutral,” it can be that “Don't aim for the green, let's just put it on the fairway” can be identified preferentially as the advice information 53.

It should be noted that when the above-described pieces of the advice information 53 are selected for the golfer 5 whose skill level 45 is “beginner” and whose playing style 47 is “aggressive,” any piece of the advice information 53 may be identified based on a predetermined standard (for example, priority or the like).

In this manner, in the information identifying step S3 of this embodiment, it can be possible that a piece of the advice information 53 suitable for the golfer 5 performing a shot can be identified from the advice information table 51 including the plurality of pieces of the advice information 53.

As with the embodiment described above, in the information providing method (information providing system 1) of this embodiment, it can be possible that the piece of the advice information 53 suitable for the golfer 5 can be output from the portable terminal 2 in a manner perceptible to the golfer 5. Thereby, according to the information providing method (information providing system 1) of this embodiment, it can be possible that useful information suitable for the golfer 5 can be provided in various situations without asking the golfer 5 to perform special operation (for example, a text input or the like).

### Golfer-Oriented Information Providing Method (Third Embodiment)

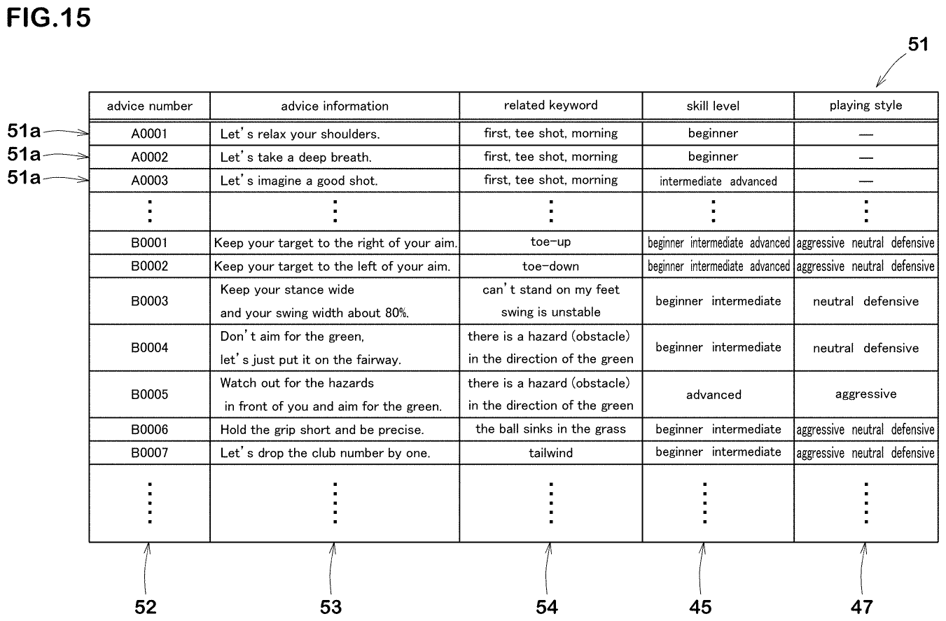

In the information providing method of the embodiments described above, the advice information 53 relating to the mind (mentality) of the golfer 5 or the advice information 53 relating to the shot (skill) of the golfer 5 can be provided. However, it is not limited to such embodiments. In the information providing method, for example, the advice information 53 relating to the mind (mentality) of the golfer 5 and the advice information 53 relating to the shot (skill) of the golfer 5 may be provided. FIG. 15 is a diagram showing the structure of the advice information table 51 of still another embodiment of the present disclosure.

As shown in FIG. 15, the advice information table 51 of this embodiment can be a combination of the advice information table 51 relating to the mind (mentality) shown in FIG. 5 and the advice information table 51 relating to the shot (skill) shown in FIG. 1. In the information providing method of this embodiment, in step S33 shown in FIG. 10, it can be possible that the piece of the advice information 53 relating to both of the mind (mentality) of the golfer 5 and the shot (skill) of the golfer 5 can be retrieved from the advice information table 51 shown in FIG. 15. Therefore, it can be possible that useful information suitable for the golfer 5 can be provided in more varied situations.

### Information Providing System (Fourth Embodiment)

While the information providing system 1 of the embodiments described above can include the portable terminal 2 and the computer 3 as shown in FIG. 1, this is not limited to such embodiments. The information providing system 1 may have only of the portable terminal 2 (and not the computer 3).

In the information providing system 1 of this embodiment, the data portion 21 of the portable terminal 2 shown in FIG. 2 can include the unique information storage part 41A, the advice information storage part 41B, and the evaluation storage part 41C shown in FIG. 3. Further, the program portion 22 of the portable terminal 2 can include the unique information input part 42A, the voice information analyzing part 42B, the advice information identification part 42C, the advice information output part 42D, the evaluation input part 42E, and the end determination part 42F shown in FIG. 3.

In the unique information input step S1 of this embodiment, the unique information of the golfer 5 can be input in the portable terminal 2. Further, in the information identifying step S3, the voice information 57 (shown in FIG. 9A) emanated by the golfer 5 can be analyzed by the portable terminal 2. Then, from the advice information table 51 (FIG. 5 and FIG. 14) including the plurality of pieces of the advice information 53 recorded in advance in the portable terminal 2, the piece of the advice information 53 suitable for the golfer 5 can be identified. Furthermore, in the evaluation input step S5, the evaluation (55b) on the piece of the advice information 53 by the golfer 5 can be input in the portable terminal 2.

In this manner, it can be possible that the information providing system 1 of this embodiment can perform the information providing method of the embodiments described above only with the portable terminal 2 even if the portable terminal 2 and the computer 3 are not connected via the communication network 4.

While detailed description has been made of the especially preferred embodiments of the present disclosure, the present disclosure can be embodied in various forms without being limited to the illustrated embodiments.

An object of the present disclosure, among one or more objects, can be to provide an information providing method and an information providing system that enable golfers to more easily receive useful advice information which is helpful for golf play.

### [Statement of Disclosure]

The present disclosure includes the following aspects.

The present disclosure 1 can pertain to a golfer-oriented information providing method for providing information to a golfer, including

a voice information acquiring step of acquiring, by a portable terminal, voice information emanated by the golfer,

an information identifying step of analyzing the voice information by the portable terminal or a computer with the voice information received from the portable terminal to identify a piece of advice information suitable for the golfer from an advice information table including a plurality of pieces of the advice information recorded in advance in the portable terminal or the computer, and

an information output step of outputting the piece of the advice information identified in the information identifying step from the portable terminal in a manner perceptible to the golfer.

The present disclosure 2 is the golfer-oriented information providing method according to the present disclosure 1, further including a unique information input step of inputting unique information of the golfer into the portable terminal or the computer prior to the information identifying step, wherein

the information identifying step preferentially identifies a piece of the advice information associated with the unique information from the plurality of pieces of the advice information.

The present disclosure 3 is the golfer-oriented information providing method according to the present disclosure 2, wherein

the unique information includes at least one of a skill level of the golfer, a playing style of the golfer, and a carry for each golf club number.

The present disclosure 4 is the golfer-oriented information providing method according to the present disclosure 1, further including, after the information output step, an evaluation input step of inputting an evaluation on the piece of the advice information by the golfer into the portable terminal or the computer, wherein

in the information identifying step performed after the evaluation input step, highly-evaluated piece of the advice information is preferentially identified from the plurality of pieces of the advice information.

The present disclosure 5 is the golfer-oriented information providing method according to the present disclosure 1, wherein

in the information identifying step, a piece of the advice information associated with a situation during play of the golfer is preferentially identified from the plurality of pieces of the advice information.

The present disclosure 6 is the golfer-oriented information providing method according to the present disclosure 5, wherein

the situation during play includes at least one of a lie, a target carry, and a wind strength.

The present disclosure 7 is the golfer-oriented information providing method according to the present disclosure 1, wherein

the information identifying step includes

a step of generating text information from the voice information,

a step of extracting one or more keywords from the text information, and

a step of retrieving, from the advice information table, one or a plurality of pieces of the advice information associated with the one or more keywords.

The present disclosure 8 is a golfer-oriented information providing system for providing information to a golfer, comprising:

a portable terminal for acquiring voice information emanated by the golfer; and

a computer for receiving the voice information from the portable terminal, wherein

the computer executes the steps comprising:

a step of analyzing the voice information;

a step of identifying a piece of advice information suitable for the golfer from an advice information table including a plurality of pieces of the advice information recorded in advance; and

a step of outputting the identified piece of the advice information to the portable terminal in a manner perceptible to the golfer.

### DESCRIPTION OF REFERENCE SIGNS

S2 voice information acquiring step
S3 information identifying step
S4 information output step

1. A golfer-oriented information providing method for providing information to a golfer, comprising:
a voice information acquiring step of acquiring, by a portable terminal, voice information emanated by the golfer;
an information identifying step of analyzing the voice information by the portable terminal or a computer with the voice information received from the portable terminal to identify a piece of advice information suitable for the golfer from an advice information table including a plurality of pieces of the advice information recorded in advance in the portable terminal or the computer; and
an information output step of outputting the piece of the advice information identified in the information identifying step from the portable terminal in a manner perceptible to the golfer.

2. The golfer-oriented information providing method according to claim 1, further comprising a unique information input step of inputting unique information of the golfer into the portable terminal or the computer prior to the information identifying step, wherein
the information identifying step preferentially identifies a piece of the advice information associated with the unique information from the plurality of pieces of the advice information.

3. The golfer-oriented information providing method according to claim 2, wherein
the unique information includes at least one of a skill level of the golfer, a playing style of the golfer, and a carry for each golf club number.

4. The golfer-oriented information providing method according to claim 1, further comprising, after the information output step, an evaluation input step of inputting an evaluation on the piece of the advice information by the golfer into the portable terminal or the computer, wherein
in the information identifying step performed after the evaluation input step, highly-evaluated piece of the advice information is preferentially identified from the plurality of pieces of the advice information.

5. The golfer-oriented information providing method according to claim 1, wherein
in the information identifying step, a piece of the advice information associated with a situation during play of the golfer is preferentially identified from the plurality of pieces of the advice information.

6. The golfer-oriented information providing method according to claim 5, wherein
the situation during play includes at least one of a lie, a target carry, and a wind strength.

7. The golfer-oriented information providing method according to claim 1, wherein
the information identifying step includes
a step of generating text information from the voice information,
a step of extracting one or more keywords from the text information, and
a step of retrieving, from the advice information table, one or a plurality of pieces of the advice information associated with the one or more keywords.

8. A golfer-oriented information providing system for providing information to a golfer, comprising:
a portable terminal for acquiring voice information emanated by the golfer; and
a computer for receiving the voice information from the portable terminal, wherein
the computer executes the steps comprising:
a step of analyzing the voice information;
a step of identifying a piece of advice information suitable for the golfer from an advice information table including a plurality of pieces of the advice information recorded in advance; and
a step of outputting the identified piece of the advice information to the portable terminal in a manner perceptible to the golfer.
